(19) United States
(12) Patent Application Publication
(10) Pub. No.: US 2008/0302150 A1
(43) Pub. Date: Dec. 11, 2008

(54) LOCK CORE ASSEMBLY

(76) Inventors: Hsiu-Chuan Wu, Kanding Hsiang (TW); I-Chien Hsin, Banciao City (TW)

Correspondence Address: PATENTTM.US, P. O. BOX 82788, PORTLAND, OR, 97282-0788, US

(21) Appl. No.: 11/761,328

(22) Filed: Jun. 11, 2007

(51) Int. Cl. E05B 27/00

(52) U.S. Cl. 70/493

(57) ABSTRACT

A lock core assembly has a lock shell, a lock core, multiple pin assemblies and at least one anti-knock pin assembly. Each pin assembly is mounted in a mounting chamber formed radially in the lock shell and through the lock core. Each anti-knock pin assembly has an upper pin and a major spring abutting each other and is mounted in a corresponding characteristic chamber assembly with a core chamber and at least one limiting recess communicating with each other. When a burglar turns the lock core by using a lock pick to vibrate or knock the lock core, the major spring presses the upper pin to engage in the limiting recess to limit the lock core and provide a reliable and reusable burglarproof lock that need not be replaced after an attempted malicious opening.

### BACKGROUND OF THE INVENTION

1. Field of the Invention

The present invention relates to a lock core assembly, and more particularly to a lock core assembly that prevents a burglar from using a vibrating or knocking lock pick to unlock the lock core assembly and need not be replaced after an attempted malicious opening.

2. Description of Related Art

With reference to FIGS. 7-9, a conventional lock core assembly in accordance with the prior art has a lock shell (91), a lock core (92) and multiple pin assemblies (80). The lock shell (91) has a receiving hole and multiple shell chambers (911). The receiving hole is formed axially through the lock shell (91) and has an inner surface. The shell chambers (911) are formed radially in the lock shell (91), align axially with each other and communicate with the receiving hole. The lock core (92) is mounted rotatably in the receiving hole in the lock shell (91) and has an outer surface, a keyhole (921), two limiting grooves (923) and multiple core chambers (922). The keyhole (921) is formed axially in the lock core (92). The limiting grooves (923) are formed axially in the outer surface of the lock core (92). The core chambers (922) are formed radially in the outer surface of the lock core (92) between the limiting grooves (923), communicate with the key hole (921) and respectively align and communicate with the shell chambers (911) to form multiple mounting chambers (93).

The pin assemblies (80) are respectively mounted in the mounting chambers (93) and each pin assembly (80) has a lower pin (81), a middle pin (84), an upper pin (82) and a spring (83). The middle pin (84) is mounted slidably in the mounting chamber (93) and abuts the lower pin (81) at an interface. The upper pin (82) is mounted slidably in the mounting chamber (93), abuts the middle pin (84) and lies across an interface between the inner surface of the receiving hole in the lock shell (91) and the outer surface of the lock core (92) to prevent the lock core (92) from rotating relative to the lock shell (91) and to prevent the lock core assembly from being opened without a key. The spring (83) is mounted in the shell chamber (911) to press the upper pin (82) against the middle pin (84). The lower pins (81) are mounted slidably in the mounting chamber (93) and do not have uniform lengths. Therefore, in a default situation, the interfaces between the middle pins (84) and the lower pins (81) are not at a uniform level.

When a person inserts a corresponding key (94) into the key hole (921) of the lock core (92), the lower pins (81) are positioned correctly, pushing the middle pins (84) and the upper pins (82) to align the interface between the lower pin (81) and the middle pin (84) of each pin assembly (80) with the interface between the inner surface of the receiving hole in the lock shell (91) and the outer surface of the lock core (82). Therefore the key can rotate the lock core (92) relative to the lock shell (91) to unlock the lock core assembly.

However, a burglar may use a lock pick to vibrate or knock the lock core assembly and bounce the upper pins (82) from the middle pins (84) to form a gap between the upper pin (82) and the middle pin (84) of each pin assembly (80). When the gap between the upper pin (82) and the middle pin (84) of each pin assembly (80) aligns with the interface between the inner surface of the receiving hole and the outer surface of the lock core (92), the burglar can turn the lock core (92) relative to the lock shell (91) to unlock the lock core assembly.

With further reference to FIG. 9, when a burglar uses the lock pick, to bounce, knock or vibrate all the upper pins (82) away from the middle pins (84) and the lock core (92) is turned, the springs (83) press the upper pins (82) to engage in one of the limiting grooves (923) to prevent a relative rotation between the lock shell (91) and the lock core (92). Therefore, the burglar is unable to unlock the lock core assembly by a vibrating or knocking manner.

However, once the upper pins (82) have engaged the limiting groove (923), the upper pins (82) cannot be removed from the limiting groove (923). Consequently, the lock core assembly has to be entirely replaced because the lock core (92) is unable to be repositioned, which is inconvenient and uneconomical.

### SUMMARY OF THE INVENTION

The primary objective of the present invention is to provide a lock core assembly that cannot be knocked to open, and if this technique is applied the lock core assembly will freeze out the lock until the correct key is inserted.

The lock core assembly in accordance with the present invention has a lock shell, a lock core rotatably mounted in the lock shell, multiple pin assemblies and at least one anti-knock pin assembly. Each pin assembly is mounted in a mounting chamber formed radially in the lock shell and through the lock core. Each anti-knock pin assembly has an upper pin and a major spring abutting each other and is mounted in a corresponding characteristic chamber assembly with a core chamber and at least one limiting recess communicating with each other. When a burglar turns the lock core by using a lock pick to vibrate or knock the lock core, the upper pin is pressed to engage in the limiting recess formed to limit the lock core and provide a reliable burglarproof lock that need not be replaced after an attempted malicious opening.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a lock core assembly in accordance with the present invention;

FIG. 2 is a side view in partial section of the lock core assembly in FIG. 1;

FIG. 3 is a front view in partial section of the lock core assembly in FIG. 1 showing a lock core of the lock core assembly is locked;

FIG. 4 is a front view in partial section of the lock core assembly in FIG. 1 showing a key inserted into a key hole in the lock core;

FIG. 5 is an operation front view of the lock core assembly in FIG. 1 showing the lock core being turned by the key;

FIG. 6 is an operational front view of the lock core assembly in FIG. 1 showing an upper pin of the lock core assembly engaging a limiting recess formed in an outer surface of the lock core;

FIG. 7 is a side view in partial section of a conventional lock core assembly in accordance with the prior art;

FIG. 8 is a side view in partial section of the lock core assembly in FIG. 7 showing a key inserted into a lock core of the lock core assembly; and

FIG. 9 is a front view in partial section of the lock core assembly in FIG. 7 showing an upper pin of the lock core assembly engaging with a limiting groove formed in an outer surface of the lock core.

### DETAILED DESCRIPTION OF THE PREFERRED EMBODIMENT

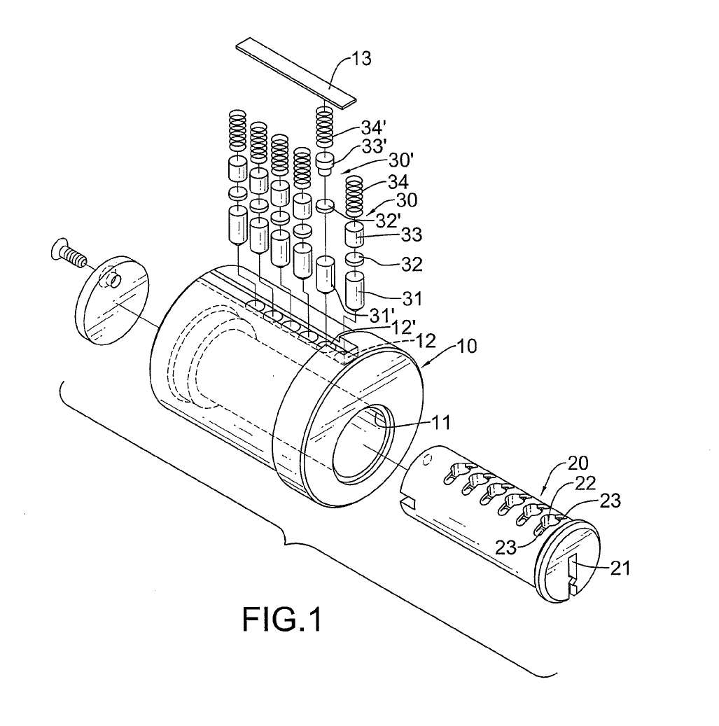

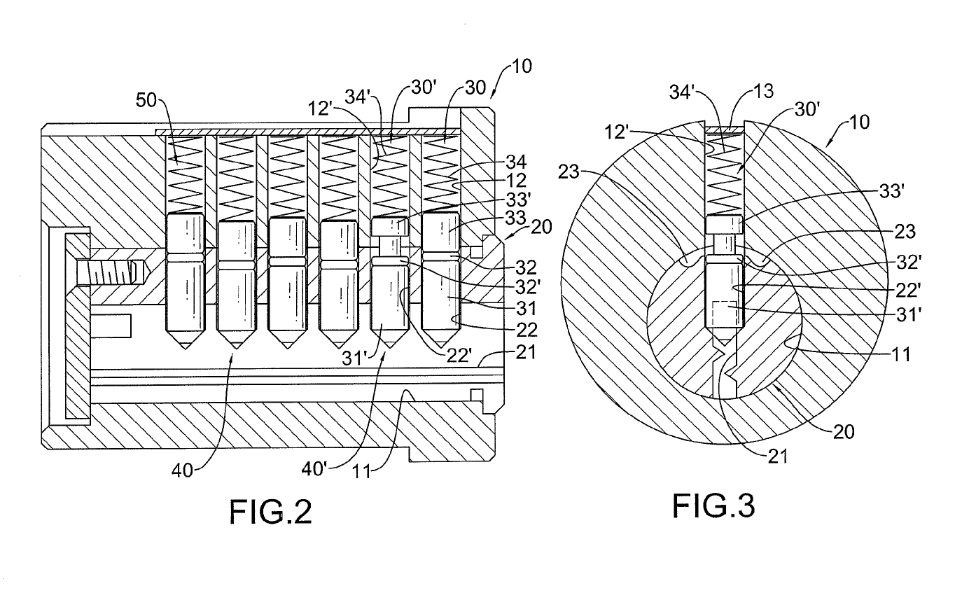

With reference to FIGS. 1 to 3, a lock core assembly in accordance with the present invention comprises a lock shell (10), a lock core (20), multiple chamber assemblies (40), at least one characteristic chamber assembly (40′), multiple pin assemblies (30), at least one anti-knock pin assembly (30′) and an optional lid (13).

The lock shell (10) has an outer surface and a receiving hole (11). The receiving hole (11) is formed axially through the lock shell (10) and has an inner surface.

The lock core (20) is mounted rotatably in the receiving hole (11) of the lock shell (10) and has an outer surface and a key hole (21). The outer surface of the lock core (20) forms an interface with the inner surface of the receiving hole (11) of the lock shell. The keyhole (21) is formed axially in the lock core (20).

The chamber assemblies (40) are parallel to each other and are formed in the lock shell (10) and the lock core (20). Each chamber assembly (40) has a mounting chamber (50). The mounting chamber (50) is formed radially in the lock shell (10) and the lock core (20) and has a core chamber (22) and a shell chamber (12). The core chamber (22) is formed radially in the lock core (20), communicates with the keyhole (11) and has two opposite sides. The opposite sides of the core chamber (22) are opposite diametrically to each other. The shell chamber (12) is formed radially in the lock shell (10), is aligned and interconnects with the core chamber (22) of a corresponding mounting chamber (50) and may communicate with the outer surface of the lock shell (10).

The at least one characteristic chamber assembly (40′) is formed in the lock shell (10) and the lock core (20). Each one of the at least one characteristic chamber assembly (40′) has a core chamber (22′) and a shell chamber (12′) and at least one limiting recess (23). The core chamber (22′) is formed radially in the lock core (20), communicates with the keyhole (11) and has two opposite sides. The opposite sides of the core chamber (22′) are opposite diametrically to each other. The shell chamber (12′) is formed radially in the lock shell (10), is aligned and interconnects with the corresponding core chamber (22′) of the characteristic chamber (40′) and may communicate with the outer surface of the lock shell (10). The at least one limiting recess (23) is formed in the outer surface of the lock core (20), is adjacent to at least one of the opposite sides of the core chamber (22′) of the characteristic chamber assembly (40′) and communicates with the core chamber (22′) of the characteristic chamber assembly (40′).

Each one of the at least one characteristic chamber assembly (40′) may have two limiting recesses (23). The two limiting recesses (23) are respectively adjacent to the opposite sides of the corresponding core chamber (22′) of the characteristic chamber assembly (40′) and may respectively extend to communicate with the core chamber (22′) of the characteristic chamber assembly (40′) and individually have a deepened distal end.

The pin assemblies (30) are respectively mounted in the mounting chambers (50) and each pin assembly (30) has a lower pin (31), a middle pin (32), an upper pin (33) and a major spring (34). The lower pin (31) is mounted slidably in a corresponding mounting chamber (50). The middle pin (32) is mounted slidably in the corresponding mounting chamber (50) and abuts the lower pin (31) to form an interface. The upper pin (33) is mounted slidably in the corresponding mounting chamber (50) and abuts the middle pin (32). The major spring (34) is mounted in the corresponding mounting chamber (50) and presses against the upper pin (33) that in turn presses against the middle pin (32) in the corresponding mounting chamber (50).

The lower pins (31) do not have uniform lengths. Therefore in a default situation, the interfaces between the middle pins (32) and the lower pins (31) are not located at a uniform level, and each of the upper pins (33) is situated at the interface between the inner surface of the receiving hole (11) in the lock shell (10) and the outer surface of the lock core (20) to prevent the lock core (20) rotating relative to the lock shell (10), meaning the lock core is locked.

The at least one anti-knock pin assembly (30′) is mounted in the corresponding characteristic chamber assembly (40′). Each one of the at least one anti-knock pin assembly (30′) has a lower pin (31′), a middle pin (32′), an upper pin (33′) and a major spring (34′). The lower pin (31′) is mounted slidably in the corresponding characteristic chamber assembly (40′). The middle pin (32′) is mounted slidably in the corresponding characteristic chamber assembly (40′) and abuts the lower pin (31′) to form an interface. The upper pin (33′) is mounted slidably in the corresponding characteristic chamber assembly (40′), abuts the middle pin (32) and selectively blocks in the corresponding limiting recess (23). The major spring (34) is mounted in the corresponding characteristic chamber assembly (40′) and presses against the upper pin (33) that in turn presses against the middle pin (32) in the corresponding characteristic chamber assembly (40′).

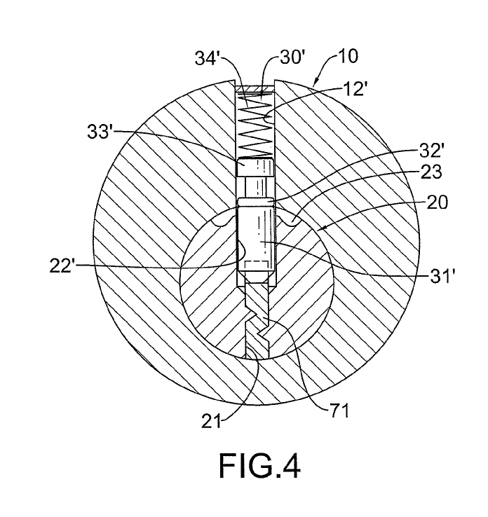

With further reference to FIGS. 4 and 5, a person can insert a key (71) into the key hole (21) of the lock core (20) to correctly position the lower pins (31, 31′), the middle pins (32, 32′) and the upper pins (33, 33′) to align the interfaces between the lower pins (31, 31′) and the middle pins (32, 32′) of the pin assemblies (30) and the at least one anti-knock pin assembly (30′) with the interfaces between the inner surfaces of the receiving holes (11) in the lock shell (10) and the outer surface of the lock core (20). Then turn the key to rotate the lock core (20) relative to the lock shell (10) to unlock the lock core assembly.

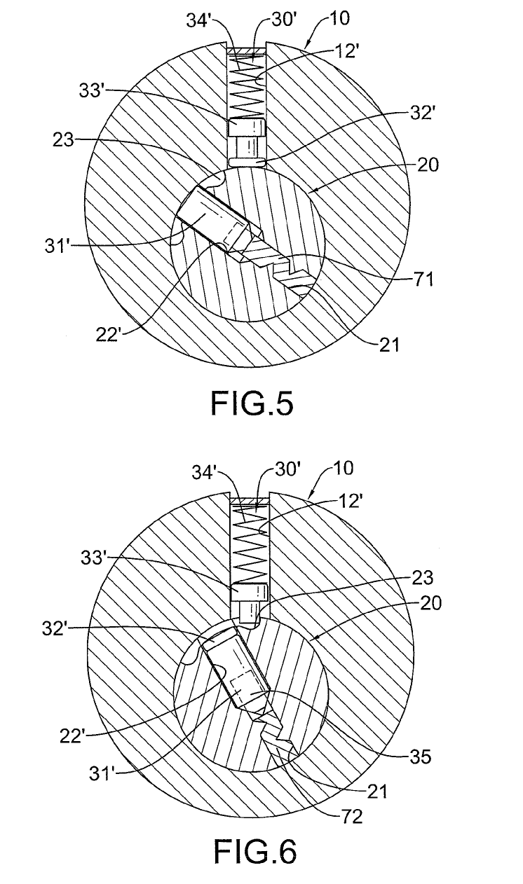

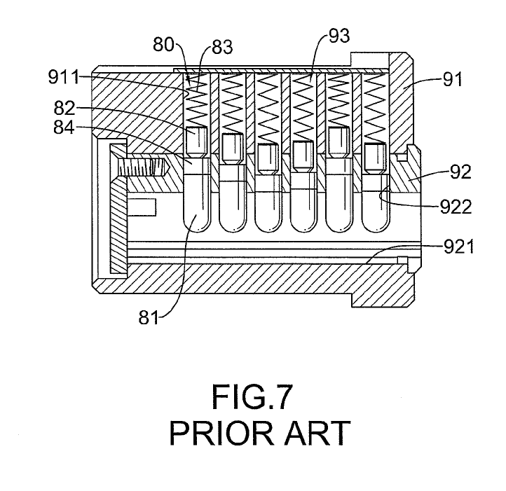

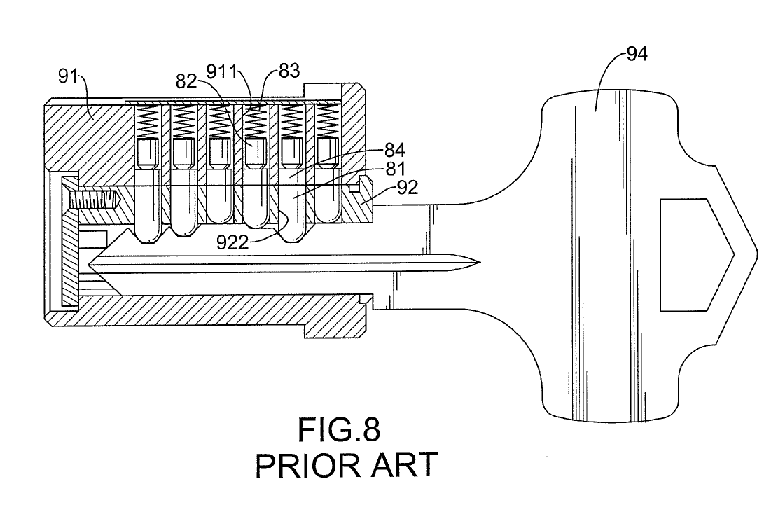

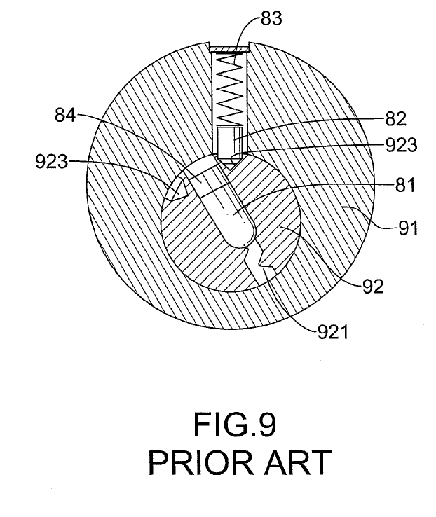

With further reference to FIG. 6, when a burglar uses a lock pick (72) to vibrate or knock the lock core assembly to detach all the upper pins (33, 33′) from the middle pins (32, 32′) to form a clearance aligning with the interfaces between the inner surfaces of the receiving holes (11) in the lock shell (10) and the outer surface of the lock core (20), and turns the lock core, the major spring (34′) of each anti-knock pin assembly (30′) presses the upper pin (33′) of each anti-knock pin assembly (30′) to engage in the limiting recess (23) of the lock core (20). The upper pin (33′) of each anti-knock pin assembly (30′) engages firmly in the deepened distal end of the limiting recess (23) and prevents the relative rotation between the lock shell (10) and the lock core (20), so that the burglar is unable to unlock the lock core assembly by a vibrating or knocking manner.

When the person inserts the key (71) into the key hole (21) to turn back the lock core (20), the upper pin (33′) of each anti-knock pin assembly (30′) disengages from the limiting recess (23). Therefore, the lock core (20) can be unlocked by a person and the lock core assembly does not require replacement.

The lid (13) is mounted on the outer surface of the lock shell (10) and covers the shell chambers (12. 12′) to prevent the pin assemblies (30, 30′) from detaching from the shell chambers (12, 12′).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lock core assembly comprising:
a lock shell having
an outer surface; and
a receiving hole being formed axially through the lock shell and having an inner surface;
a lock core being mounted rotatably in the receiving hole in the lock shell and having
an outer surface; and
a key hole being formed axially in the lock core;
multiple chamber assemblies being parallel to each other and formed in the lock shell and the lock core and each chamber assembly having
a mounting chamber being formed radially in the lock shell and the lock core and having
a core chamber being formed radially in the lock core, communicating with the key hole and having
two opposite sides opposite diametrically to each other; and
a shell chamber being formed radially in the lock shell, aligned and interconnecting with the core chamber of a corresponding mounting chamber; and
at least one characteristic chamber assembly formed in the lock shell and the lock core, and each one of the at least one characteristic chamber having
a core chamber being formed radially in the lock core, communicating with the key hole and having
two opposite sides opposite diametrically to each other; and
a shell chamber being formed radially in the lock shell, aligned and interconnecting with the core chamber of the characteristic chamber assembly;
at least one limiting recess being formed in the outer surface of the lock core, being adjacent to at least one of the opposite sides of the core chamber of the characteristic chamber assembly and communicating with the core chamber of the characteristic chamber assembly; and
multiple pin assemblies being mounted respectively in the mounting chambers, and each pin assembly having
a lower pin being mounted slidably in a corresponding mounting chamber;
a middle pin being mounted slidably in the corresponding mounting chamber and abutting the lower pin;
an upper pin being mounted slidably in the corresponding mounting chamber and abutting the middle pin;
a major spring being mounted in the corresponding mounting chamber and pressing against the upper pin that in turn presses against the middle pin in the corresponding mounting chamber; and
at least one anti-knock pin assembly being mounted respectively in the at least one characteristic chamber assembly, and each one of the at least one anti-knock pin assembly having
a lower pin being mounted slidably in a corresponding characteristic chamber assembly;
a middle pin being mounted slidably in the corresponding characteristic chamber assembly and abutting the lower pin;
an upper pin being mounted slidably in the corresponding characteristic chamber assembly, abutting the middle pin and selectively blocking in a corresponding limiting recess;
a major spring being mounted in the corresponding characteristic chamber assembly and pressing against the upper pin that in turn presses against the middle pin in the corresponding characteristic chamber assembly.

2. The lock core assembly as claimed in claim 1, wherein each of the at least one characteristic chamber assembly has two limiting recesses respectively adjacent to the opposite sides of the core chamber of a corresponding characteristic chamber assembly.

3. The lock core assembly as claimed in claim 1, wherein
the shell chambers further communicating with the outer surface of the lock shell; and
the lock core assembly further has a lid being mounted on the outer surface of the lock shell and covering the shell chambers.

4. The lock core assembly as claimed in claim 2, wherein
the shell chamber further communicating with the outer surface of the lock shell; and
the lock core assembly further has a lid being mounted on the outer surface of the lock shell and covering the shell chambers.

5. The lock core assembly as claimed in claim 1 further comprising a lid mounted on the outer surface of the lock shell and covering the shell chambers.

6. The lock core assembly as claimed in claim 4 further comprising a lid mounted on the outer surface of the lock shell and covering the shell chambers.
